(19) United States
(12) Patent Application Publication
(10) Pub. No.: US 2010/0017033 A1
(43) Pub. Date: Jan. 21, 2010

(54) ROBOTIC SYSTEMS WITH USER OPERABLE ROBOT CONTROL TERMINALS

(76) Inventor: Remus Boca, North Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/176,190

(22) Filed: Jul. 18, 2008

(51) Int. Cl. G06F 19/00

(52) U.S. Cl. 700/258; 700/264; 901/46

(57) ABSTRACT

Robotic systems and methods employ at least some communications between peripheral controllers, for example vision controller, conveyor controller, camera controller and/or inspection controller, that is independent of a robot controller or robot motion controller. Such may include a parallel communications path.

### BACKGROUND

1. Field

This disclosure generally relates to robotic systems, and particularly to robotic systems that employ user operable robot control terminals and machine vision.

2. Description of the Related Art

Robotic systems are used in a variety of settings and environments. Robotic systems typically include one or more robots having one or more robotic members that are movable to interact with one or more workpieces. For example, the robotic member may include a number of articulated joints as well as a claw, grasper, or other implement to physically engage or otherwise interact with or operate on a workpiece. For instance, a robotic member may include a welding head or implement operable to weld the workpiece. The robotic system also typically includes a robot controller comprising a robotic motion controller that selectively controls the movement and/or operation of the robotic member, for example controlling the position and/or orientation (i.e., pose). The robot motion controller may be preprogrammed to cause the robotic member to repeat a series of movements or steps to selectively move the robotic member through a series of poses.

Some robotic systems include a user operable robot control terminal to allow a user to provide input to the robot motion controller. The robot control terminal includes a variety of user input devices, for example user operable keys, switches, etc., and may include a display operable to display information and/or images. The robot control terminal is typically handheld and coupled to the robot motion controller via a cable. Typically a user employs a robot control terminal to move or step the robot through a series of poses to teach or train the robot. Hence, the user operable control terminal is typically referred to as a teaching pendant.

Some robotic systems employ machine vision to locate the robotic member relative to other structures and/or to determine a position and/or orientation or pose of a workpiece. Such robotic systems typically employ one or more image sensors, for example cameras, and a machine vision controller coupled to receive image information from the image sensors and configured to process the received image information. The image sensors may take a variety of forms, for example CCD arrays or CMOS sensors. Such image sensors may be fixed, or may be movable, for instance coupled to the robotic member and movable therewith. Robotic systems may also employ other controllers for performing other tasks. In such systems, the robot motion controller functions as the central control structure through which all information passes.

### BRIEF SUMMARY

At least one embodiment may be summarized as a machine-vision based robotic system, including a machine vision controller coupled to receive image information from at least one image sensor and configured to process at least some of the image information; a robot motion controller configured to control movement of a robotic member based at least in part on the processed image information captured by the at least one image sensor; and a teaching pendant interface communicatively coupled to provide at least some communications between a teaching pendant the robot controller and communicatively coupled to provide at least some communications between the teaching pendant and the machine vision controller directly without intervention of the robot motion controller.

The teaching pendant interface may include at least one communications channel between the teaching pendant and robot motion controller and at least one communications channel between the teaching pendant and the machine vision controller that is at least in part parallel to the communications channel between the teaching pendant and the robot motion controller. The machine vision controller may include at least a first processor and the robot motion controller including at least a second processor. The machine-vision based robotic system may further include a programmable logic controller wherein the teaching pendant interface is communicatively coupled to provide at least some communications directly between the teaching pendant and the programmable logic controller directly without intervention of the robot motion controller. The teaching pendant interface may include at least one communications channel between the teaching pendant and robot motion controller, at least one communications channel between the teaching pendant and the machine vision controller that is at least in part parallel to the communications channel between the teaching pendant and the robot motion controller, and at least one communications channel between the teaching pendant and the programmable logic controller that is at least in part parallel to the communications channel between the teaching pendant and the robot motion controller. The teaching pendant interface may be communicatively coupled to provide two-way communications between the teaching pendant and the robot motion controller and to provide two-way communications between the teaching pendant and the machine vision controller. The machine-vision based robotic may further include a robotic cell network interface communicatively coupled to provide direct two-way communications between the teaching pendant and a robotic cell network. The machine-vision based robotic system may further include an external network interface communicatively coupled to provide direct two-way communications between the teaching pendant and an external network that is external from a robotic cell. The machine-vision based robotic system may further include at least one of the robotic member, the first image sensor or the teaching pendant.

At least one embodiment may be summarized as a machine-vision based robotic system, including at least a first robotic member that is selectively movable; at least a first image sensor operable to produce information representative of images; a user operable handheld robot control terminal including at least one user input device operable by a user; a robot motion controller configured to control movement of at least the first robotic member; a machine vision controller coupled to receive information from at least the first image sensor, wherein the handheld robot control terminal and the robot motion controller are communicatively coupled to provide at least some communications between the handheld robot control terminal and the robot motion controller, and wherein the handheld robot control terminal and the machine vision controller are communicatively coupled to provide at least some communications between the handheld robot control terminal and the machine vision controller independently of the robot motion controller.

The machine vision controller may include at least a first processor and the robot motion controller may include at least a second processor. The machine-vision based robotic system may further include a programmable logic controller wherein the handheld robot control terminal is communicatively coupled in parallel to the robot motion controller and the programmable logic controller to provide at least some communications directly between the handheld robot control terminal and the programmable logic controller without intervention of the robot motion controller. The robot motion controller and the machine vision controller may each be communicatively coupleable to an external network that is external from a robotic cell. The handheld robot control terminal may include at least one display and may be configured to present images from the image sensor on the at least one display. The handheld robot control terminal may include at least one user input device being configured to provide data to the robot motion controller to move at least the first robotic member in response to operation of the user input device. The handheld robot control terminal may be a teaching pendant. The machine-vision based robotic system may further include at least one tangible communications channel providing communications between the handheld robot control terminal and the robot motion controller. The machine-vision based robotic system may further include a communications conduit that carries bidirectional asynchronous communications between the handheld robot control terminal and both the robot motion controller and the machine vision controller. The machine-vision based robotic system may further include at least a robotic cell network that carries bidirectional communications between the handheld robot control terminal and both the robot motion controller and the machine vision controller.

At least one embodiment may be summarized as a method of operating a machine vision system, including providing at least some communications between a teaching pendant and a robot motion controller; providing at least some communications between the teaching pendant and a machine vision controller independently of the robot motion controller; and causing a robot member to move in response to communications between the teaching pendent and the robot motion controller.

Providing at least some communications between the teaching pendant and a machine vision controller independently of the robot motion controller may include providing at least some communications along an independent communications path at least a portion of which is parallel to a communications path between the teaching pendant and the robot motion controller. Providing at least some communications between the teaching pendant and a machine vision controller independently of the robot motion controller may include providing at least some communications via a robotic cell bidirectional asynchronous communications network. The method of operating a machine vision system may further include displaying a representation of data from the robot motion controller at the teaching pendant in real time; and displaying a representation of data from the machine vision controller at the teaching pendant in real time. The representation of data from the machine vision controller may be displayed at the teaching pendant concurrently with the representation of data from the robot motion controller. Providing at least some communications between the teaching pendant and a machine vision controller independently of the robot motion controller may include transmitting image data from the machine vision controller to the teaching pendant for display thereby directly without intervention of the robot motion controller. The method of operating a machine vision system may further include providing at least some communications between a processor of the machine vision controller and a processor of the robot motion controller. The method of operating a machine vision system may further include providing at least some communications between the teaching pendant and a third controller independently of the robot motion controller. The method of operating a machine vision system may further include providing communications between the robot motion controller and an external network that is external from a robotic cell; and providing communications between the machine vision controller and the external network. The method of operating a machine vision system may further include prompting a user for a user input at the teaching pendant in response to at least some of the communications between the teaching pendant and the vision controller; and receiving at least one user input at the teaching pendant, wherein providing at least some communications between the teaching pendant and the machine vision controller may include transmitting at least one signal indicative of the at least one user input from the teaching pendant to the machine vision controller independently of the robot motion controller. The method of operating a machine vision system may further include performing a discover service on the teaching pendant. Performing a discover service on the teaching pendant may include identifying any new hardware added to a robotic cell since a previous discover service action. Performing a discover service on the teaching pendant may include identifying any new software added to a robotic cell since a previous discover service action.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of an environment including a robotic cell communicatively coupled to an external network, the robotic cell including a robot system, a vision system, conveyor system, teaching pendant and pendant interface, according to one illustrated embodiment.

FIG. 2 is a schematic diagram of a vision controller according to one illustrated embodiment.

FIG. 3 is a schematic diagram of a robot controller according to one illustrated embodiment.

FIG. 4 is a schematic diagram of a conveyor controller according to one illustrated embodiment.

FIG. 5 is a schematic diagram of a camera controller according to one illustrated embodiment.

FIG. 6 is a schematic diagram of a robotic system where a robot controller includes a robot motion controller, a vision controller, and optionally a third controller, each separately communicatively coupled to a teaching pendant, according to one illustrated embodiment.

FIG. 7 is a schematic diagram showing a robotic system including a robot controller including a robot motion controller, a vision controller, and optionally a third controller communicatively coupled to a teaching pendant to provide at least some communications between the teaching pendant and the vision controller and/or third party controller that are independent from the robot motion controller, according to one illustrated embodiment.

FIG. 8 is a schematic diagram showing a robotic system including a robot motion controller, a vision controller and teaching pendant communicatively coupled via a network, according to one illustrated embodiment.

FIG. 9 is a schematic diagram of a robotic system including a robot controller that includes a robot motion controller and vision controller communicatively coupled to a teaching pendant, according to another illustrated embodiment.

FIG. 10 is a schematic diagram showing a robotic system including a robot controller, vision controller and inspection controller, each independently communicatively coupled to a teaching pendant and to a network, according to one illustrated embodiment.

FIG. 11 is a schematic diagram showing a robotic system including a robot controller and vision controller each communicatively coupled to a teaching pendant and to each other, and further communicatively coupled to an external network, according to another illustrated embodiment.

FIGS. 12A-12B are a flow diagram showing a method of operating a robotic system according to one illustrated embodiment.

FIG. 13 is a flow diagram showing a method of operating a vision controller and a teaching pendant, according to one illustrated embodiment.

FIG. 14 is a flow diagram showing a method of operating a vision controller and a teaching pendant, according to one illustrated embodiment.

FIG. 15 is a screen print of a portion of a user interface on a teaching pendant illustrating the display of data received separately from a robot controller and from a vision controller, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with robots, networks, image sensors and controllers have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

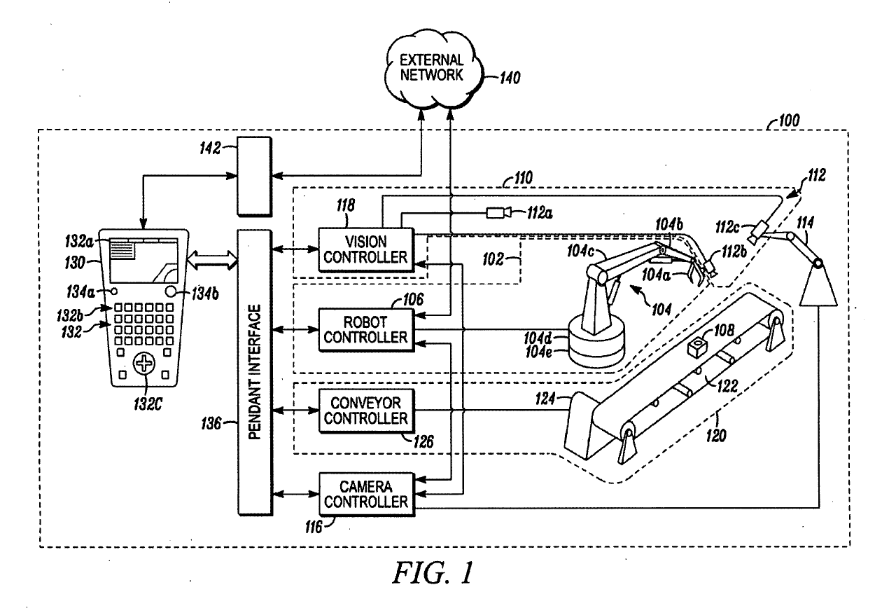

FIG. 1 shows a robotic cell 100 according to one illustrated embodiment.

The robotic cell 100 includes a robotic system (delineated by broken line) 102 which includes one or more robots 104 and one or more robot controllers 106. The robot 104 includes one or more robotic members 104a-104c which are selectively movable into a variety of positions and/or orientations (i.e., poses) via one or more actuators such as motors, hydraulic or pneumatic pistons, gears, drives, linkages, etc. The robot 104 may also include a pedestal 104d rotatably mounted to a base 104e, which may be driven by one or more actuators. The robot controller 106 is communicatively coupled to the robot 104 to provide control signals to control movement of the robotic members 104a-104d. As used herein and in the claims, the term coupled and variations thereof (e.g., couple, coupling, couples) means directly or indirectly connected where logically or physically. The communicative coupling may also provide feedback from the robot 104, for example feedback from one or more position or orientation sensors such as rotational encoders, force sensors, acceleration sensors, gyroscopes, etc., which may be indicative of a position or orientation or pose of one or more parts of the robot 104.

The robot controller 106 may be configured to provide signals that cause the robot 104 to interact with one or more workpieces 108. The workpieces can take any of a variety of forms, for example parts, vehicles, parcels, items of food, etc. Interaction may take a variety of forms, for example physically engaging the workpiece, moving or rotating the workpiece, or welding the workpiece, etc.

The robotic cell 100 may also include a vision system (delineated by broken line) 110. The vision system may include one or more image sensors such as cameras 112a-112c (collectively 112). The cameras 112 may take a variety of forms, for example CCD based or CMOS based cameras. The cameras 112 may, for instance take the form of digital still cameras, analog video cameras and/or digital video cameras. One or more of the cameras 112 may be stationary or fixed, for example camera 112a. One or more of the cameras 112 may be mounted for movement with a portion of the robot 104, for example camera 112b. One or more of the cameras 112 may be mounted for movement independently of the robot 104, for example camera 112c. Such may, for example, be accomplished by mounting the camera 112c to a portion of a secondary robot 114, the position and/or orientation or pose of which is controlled by a camera controller 116. The camera controller 116 may be communicatively coupled to control the secondary robot 114 and/or receive feedback regarding a position and/or orientation or pose of the secondary robot 114 and/or camera 112c.

The vision system 110 includes a vision controller communicatively coupled to receive image information from the cameras 112. The vision controller may be programmed to process or preprocess the received image information. In some embodiments, the vision system may include one or more frame grabbers (not shown) to grab and digitize frames of analog video data. The vision controller 118 may be directly communicatively coupled to the robot controller 106 to provide processed or preprocessed image information. For instance, the vision controller 118 may provide information indicative of a position and/or orientation or pose of a workpiece to the robot controller. The robot controller 106 may control a robot 104 in response to the processed or preprocessed image information provided by the vision controller 118.

The robotic cell 100 may further include a conveyor subsystem (delineated by broken line) 120 which may be used to move workpieces 108 relative to the robotic cell 100 and/or robot 104. The conveyor subsystem 120 may include any variety of structures to move a workpiece 108, for example a conveyor belt 122, and a suitable drive to drive the conveyor belt 122, for example a motor 124.

The conveyor subsystem 120 may also include a conveyor controller 126. The conveyor controller 126 may be communicatively coupled to control movement of the conveyor structure, for example supplying signals to control the operation of motor 124 and thereby control the position, speed, or acceleration of the conveyor belt 122. The conveyor controller 126 may also be communicatively coupled to receive feedback from the motor 124, conveyor belt 122 and/or one or more sensors. For example, the conveyor controller 126 can receive information from a rotational encoder or other sensor. Such information may be used to determine a position, speed, and/or acceleration of the conveyor belt 122. The conveyor controller 126 may be communicatively coupled with the robot controller 106 to receive instructions therefrom and to provide information or data thereto.

Robotic cell 100 may also include a user operable robot control terminal 130 that may be used by a user to control operation of the robot 104. In particular, the user operable robot control terminal 130 may take the form of a handheld device including a user interface 132 that allows a user to interact with the other components of the robotic cell 100. The user operable robot control terminal 130 may be referred to as a teaching pendant.

The robot control terminal or teaching pendant 130 may take a variety of forms including desktop or personal computers, laptop computers, workstations, main frame computers, handheld computing devices such as personal digital assistants, Web-enabled BLACKBERRY® OR TREO® type devices, cellular phones, etc. Such may allow a remote user to interact with the robotic system 102, vision system 110 and/or other components of the robotic cell 100 via a convenient user interface 132. As explained in more detail below, the user interface 132 may take a variety of forms including keyboards, joysticks, trackballs, touch or track pads, hepatic input devices, touch screens, CRT displays, LCD displays, plasma displays, DLP displays, graphical user interfaces, speakers, microphones, etc.

The user interface 132 may include one or more displays 132a operable to display images or portions thereof captured by the cameras 112. The display 132a is also operable to display information collected by the vision controller 118, for example position and orientation of various cameras 112. The display 132 is further operable to display information collected by robot controller 106, for example information indicative of a position and/or orientation or pose of the robot 104 or robotic members 104a-104d. The display 132a may be further operable to present information collected by the conveyor controller 126, for example position, speed, or acceleration of conveyor belt 122 or workpiece 108. The display 132a may further be operable to present information collected by the camera controller 116, for example position or orientation or pose of secondary robot 114 or camera 112c.

The user interface 132 may include one or more user input devices, for example one or more user selectable keys 132b, one or more joysticks, rocker switches, trackpads, trackballs or other user input devices operable by a user to input information into the robot control terminal 130.

The user interface 132 of the robot control terminal 130 may further include one or more sound transducers such as a microphone 134a and/or a speaker 134b. Such may be employed to provide audible alerts and/or to receive audible commands. The user interface may further include one or more lights (now shown) operable to provide visual indications, for example one or more light emitting diodes (LEDs).

The robot control terminal 130 is communicatively coupled to the robot controller 106 via a robot control terminal interface 136. The robot control terminal 130 may also include other couplings to the robot controller 106, for example to receive electrical power (e.g., a Universal Serial Bus USB), to transmit signals in emergency situations, for instance to shut down or freeze the robot 104.

The robot control terminal interface 136 may also provide communicative coupling between the robot control terminal 130 and the vision controller 118 so as to provide communications therebetween independently of the robot controller 106. In some embodiments, the robot control terminal interface 136 may also provide communications between the robot control terminal 130 and the conveyor controller 126 and/or camera controller 116, independently of the robot controller 106. Such may advantageously eliminate communications bottlenecks which would otherwise be presented by passing communications through the robot controller 106 as is typically done in conventional systems.

The robot control terminal 130 may be communicatively coupled to an external network 140 via an external network interface 142. The vision controller 118 may also be communicatively coupled to the external network 140.

The various communication paths illustrated by arrows in FIG. 1 may take a variety of forms including wired and wireless communication paths. Such may include wires, cables, networks, routers, servers, infrared transmitters and/or receivers, RF or microwave transmitters or receivers, and other communication structures. Some communications paths may be specialized or dedicated communications paths between respective pairs or other groups of controllers to provide efficient communications therebetween. In some embodiments, these communications paths may provide redundancy, for example providing communications when another communications path fails or is slow due to congestion.

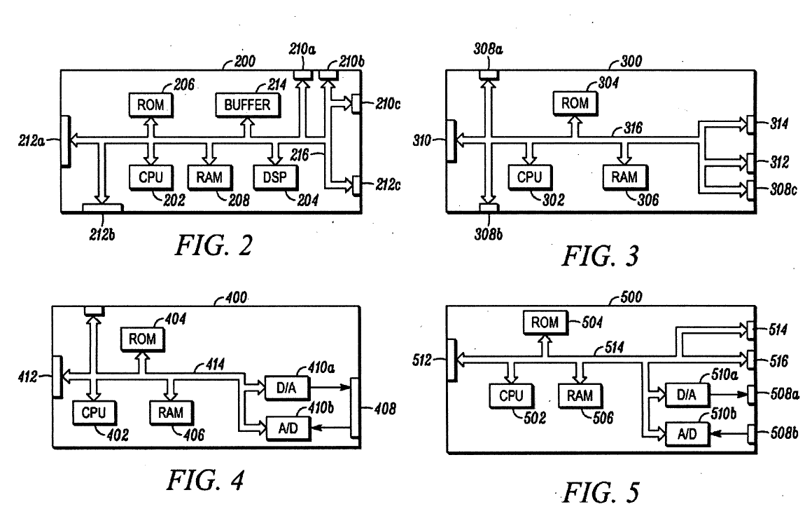

FIG. 2 shows a vision controller 200 according to one illustrated embodiment.

The vision controller 200 includes one or more processors such as a central processing unit 202 (e.g., microprocessor, microcontroller, application specific integrated circuit, field programmable gate array, etc.) and/or digital signal processor (DSP) 204 operable to process or preprocess image information received from the cameras 112 (FIG. 1). For instance, the vision controller 200 may be configured to perform pose estimation, determining a position and orientation of a workpiece in some reference frame (e.g., camera reference frame, robot reference frame, real world reference frame, etc.). The vision controller 200 may employ any of the numerous existing techniques and algorithms to perform such pose estimation. The vision controller 200 may include one or more processor readable memories, for example read-only memory (ROM) 206 and/or random access memory (RAM) 208. The central processing unit 202 of the vision controller 200 may execute instructions stored in ROM 204 and/or RAM 206 to control operation process or preprocess image information.

The vision controller may include one or more camera communications ports 210a-210c that provide an interface to the cameras 112a-112c, respectively. The vision controller 200 may include one or more robot control terminal communication ports 212a to provide communications with the robot control terminal 130 and which may be considered part of the robot control terminal interface 136. The vision controller 200 may include a robot controller communications port 212b that functions as an interface with the robot controller 106 (FIG. 1). The vision control 200 may further include a camera controller communications port 212c to that functions as an interface with the camera controller 116 (FIG. 1). The vision controller 200 may include one or more buffers 214 operable to buffer information received via the camera communications ports 210a-210c or 212a-212c. The various components of the vision controller 118 may be coupled by one or more buses 216. The buses 216 may take the form or one or more communications buses, data buses, instruction buses, and/or power buses.

FIG. 3 shows a robot controller 300 according to one illustrated embodiment.

The robot controller 300 may include one or more processors, for example, a central processing unit 302 (e.g., microprocessor, microcontroller, application specific integrated circuit, field programmable gate array, etc.). The robot controller 300 may include one or more processor readable memories, for example ROM 304 and/or RAM 306. The central processing unit 302 of the robot controller 300 may execute instructions stored in ROM 304 and/or RAM 306 to control operation (e.g., motion) of the robot 104. In some embodiments, the robot controller may perform processing or post-processing on the image information, for example performing pose estimation. Such may allow the robot controller 300 to determine a pose of the workpiece 108 (FIG. 1), the robot 104, or some other structure or element of the robotic cell 102. Such embodiments may or may not employ a vision controller, but may employ other controllers, for example a camera controller, conveyor controller, inspection controller or other controller.

The robot controller 300 may include a vision controller communications port 308a to provide communications with the vision controller 118 (FIG. 1). The robot controller 300 may also include a conveyor controller communications port 308b to provide communications with the conveyor controller 126 (FIG. 1) and a camera controller communications port 308c to provide communications with the camera controller 116 (FIG. 1). The robot controller 300 may include a port 310 to provide communications with the robot control terminal 130 (FIG. 1) which may form part of the interface 136. The robot controller may further include a robot communications port 312 to provide communications with the robot 104 (FIG. 1). Additionally, the robot controller 300 may include a port 314 to provide communications with the external network 140 (FIG. 1). The various components of the robot controller 300 may be coupled by one or more buses 316. The buses 316 may take the form or one or more communications buses, data buses, instruction buses, and/or power buses.

FIG. 4 shows a conveyor controller 400 according to one illustrated embodiment.

The conveyor controller 400 may include one or more processors such as central processing unit 402 (e.g., microprocessor, microcontroller, application specific integrated circuit, field programmable gate array, etc.). The conveyor controller 400 may include one or more processor readable memories such as ROM 404 and/or RAM 406. The central processing unit 402 of the conveyor controller 400 may execute instructions stored in ROM 304 and/or RAM 306 to control operation (e.g., position, motion, speed, acceleration) of the conveyor belt 122 or motor 124.

The conveyor controller 400 may include one or more interfaces to provide communications with a conveying system or portion thereof such as motor 124. The conveyor controller 400 can include a digital-to-analog converter 410a to convert digital signals from the central processing unit 402 into analog signals suitable for control of the motor 124 (FIG. 1). The conveyor controller 400 may also include an analog-to-digital converter 410b to convert analog information collected from the motor 124 or sensor (not shown) into a form suitable for use by the central processing unit 402. The conveyor controller 400 may include one or more conveyor communications ports 408 (only one shown) to provide communications between the converters 410a, 410b and the motor 124, other actuators (not shown) and/or sensors. The conveyor controller 400 may further include a robot control terminal communications port 412 that provides direct communications with the robot control terminal 130 independently of the robot controller 106 (FIG. 1) and thus may form part of the robot control terminal communications interface 136 (FIG. 1). One or more of the components of the conveyor controller 400 may be coupled by one or more buses 414. The buses 414 may take the form or one or more communications buses, data buses, instruction buses, and/or power buses.

FIG. 5 shows a camera controller 500 according to one illustrated embodiment.

The camera controller 500 may include one or more processors such as central processing unit 502 (e.g., microprocessor, microcontroller, application specific integrated circuit, field programmable gate array, etc.). The camera controller 500 may include one or more processor readable memories, for example, ROM 504 and/or RAM 506. The central processing unit 502 of the camera controller 500 may execute instructions stored in ROM 504 and/or RAM 506 to control operation of the auxiliary robot 114 (FIG. 1), for example controlling position, orientation or pose of the auxiliary robot 114 and hence the camera 112c carried thereby. While illustrated as controlling only a single auxiliary robot 114, the camera controller 500 may control multiple auxiliary robots (not shown), or the robotic cell may include multiple camera controllers (not shown) to control respective auxiliary robots.

The camera controller 500 may include one or more interfaces to provide communications with the auxiliary robot 114 (FIG. 1). For example, the camera controller 500 may include a D/A 510a to convert digital signals from the central processing unit 502 into an analog form suitable for controlling the auxiliary robot 114. The camera controller 500 may also include an A/D converter 510b to convert analog signals collected by one or more sensors or encoders associated with the auxiliary robot 114 into a form suitable for use by the central processor unit 502. The camera controller 500 may include one or more auxiliary robot communications ports 508a -508b to provide communications between the converters 510a, 510b and the auxiliary robot 114 (FIG. 1) and/or sensors (not shown). The camera controller 500 may also include a robot control terminal communications port 512 to provide communications with the robot control terminal 130, independently of the robot controller 106. The camera controller 500 may also include a robot controller communications port 514 to provide communications with the robot controller 106 (FIG. 1) and/or a vision controller communications port 516 to provide communications with the vision controller 118 (FIG. 1). The various components of the camera controller 500 may be coupled by one or more buses 514. The buses 514 may take the form or one or more communications buses, data buses, instruction buses, and/or power buses.

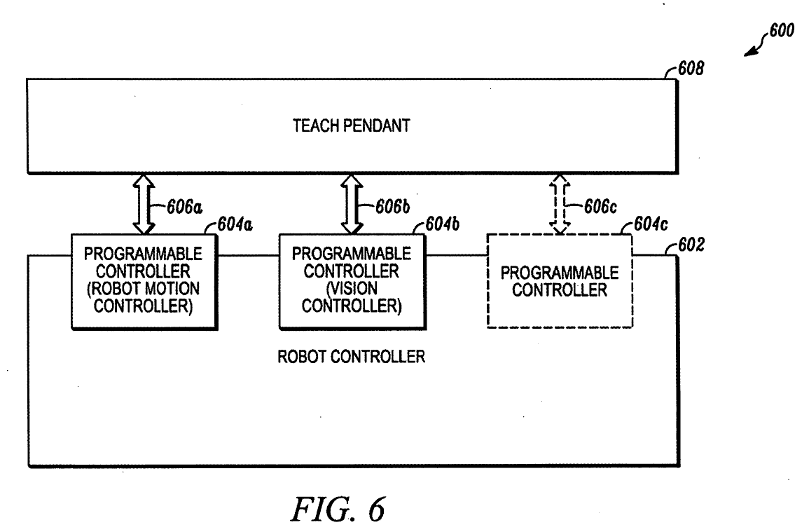

FIG. 6 shows a portion of a robotic cell 600 according to one illustrated embodiment.

The robotic cell 600 includes a robot controller 602 having a number of distinct programmable controllers, collectively 604. The programmable controllers may include a robot motion controller 604a, a vision controller 604b, and optionally another programmable controller 604c (e.g., conveyor controller, camera controller, inspection controller). The robotic cell 600 also includes a robot control terminal in the form of a teaching pendant 608. Each of the programmable controllers 604a-604c is at least logically independently communicatively coupled 606a -606b (collectively 606) to the teaching pendant 608. This advantageously provides communications directly between the teaching pendant 608 and the vision controller 606b, without the intervention of the robot motion controller 606a. This also advantageously provides communications directly between the teaching pendant 608 and the other programmable controller 606c, without the intervention of the robot motion controller 606a. In some embodiments the logical independence is provided via a network infrastructure, while in other embodiments the logical independence is provided by physically independent communications paths or channels.

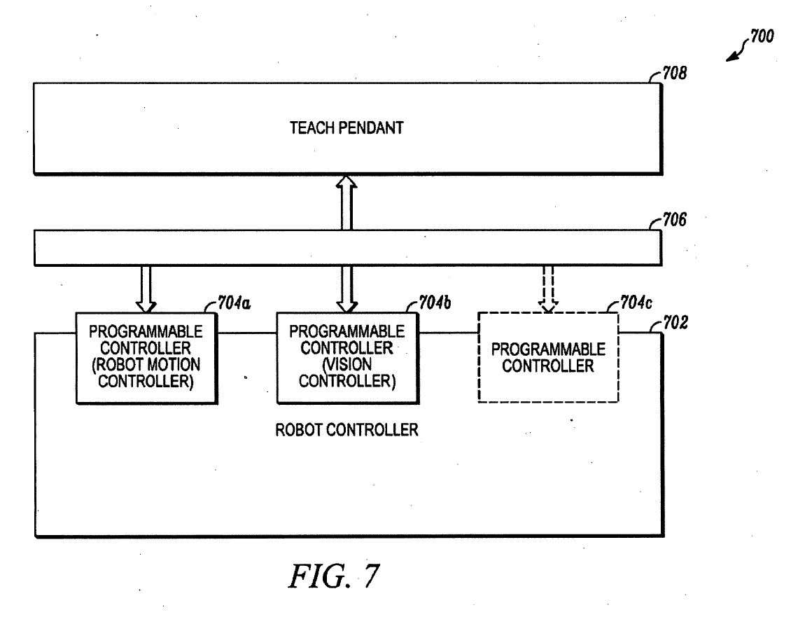

FIG. 7 shows a portion of a robotic cell 700 according to another illustrated embodiment.

The robotic cell 700 includes a robot controller 702 having a number of distinct programmable controllers, collectively 704. The programmable controllers may include a robot motion controller 704a, a vision controller 704b, and optionally another programmable controller 704c (e.g., conveyor controller, camera controller, inspection controller). The robotic cell 700 also includes a robot control terminal in the form of a teaching pendant 708. The programmable controllers 704 are communicatively coupled to the teaching pendant 708 via a communications path 706. At least a portion of the communications path 706 between the teaching pendant 708 and the vision controller 704b is in parallel to a portion of the communication path 706 between the teaching pendant 708 and the robot motion controller 704a. This advantageously provides communications directly between the teaching pendant 708 and the vision controller 706b, without the intervention of the robot motion controller 706a. Optionally, at least a portion of the communications path 706 between the teaching pendant 708 and the other programmable controller 704c is in parallel to a portion of the communication path 706 between the teaching pendant 708 and the robot motion controller 704a. This advantageously provides communications directly between the teaching pendant 708 and the other programmable controller 706c, without the intervention of the robot motion controller 706a.

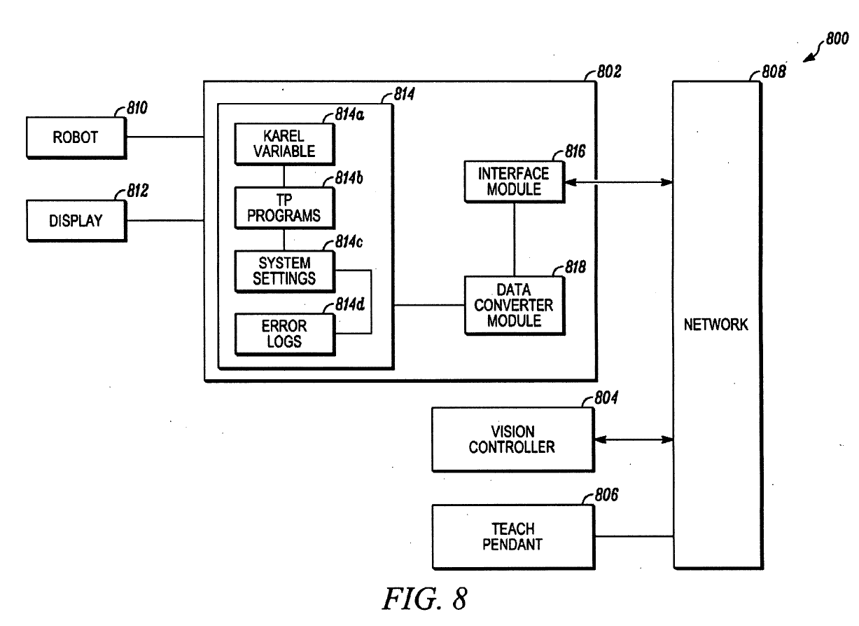

FIG. 8 shows a robotic cell 800 according to another illustrated embodiment.

The robotic cell 800 includes a robot controller 802, a separate vision controller 804, and a robot control terminal in the form of teaching pendant 806. The robot controller 802, vision controller 804, and teaching pendant 806 are communicatively coupled via a network 808. The network 808 advantageously provides communications between the teaching pendant 806 and the vision controller 804 independently from communications between the teaching pendant 806 and the robot controller 802.

The robotic cell 800 may also include a robot 810 communicatively coupled to the robot controller 802. The robotic cell may further include a display 812 communicatively coupled to the robot controller 802.

The robot controller 802 may include a control system 814 which may take the form of a processor, processor readable memory, software instructions stored in the processor readable memory and executed by the processor, firmware instruction (e.g., field programmable gate array), and/or hardwired circuitry (e.g., Application Specific Integrated Circuits). The control system 814 may store one or more variable memory spaces (denoted in the Figure as Karel variables) 814a, teaching pendant programs 814b, system settings 814c, and/or one or more error logs 814d. The robot controller 802 is configured to control the motion of the robot 922.

The robot controller 802 may also include an interface module 816 to provide communications with the network 808. The robot controller 802 may further include a data converter module 818 to convert data into a form suitable for communication via the network 808 and/or processing by the control system 814.

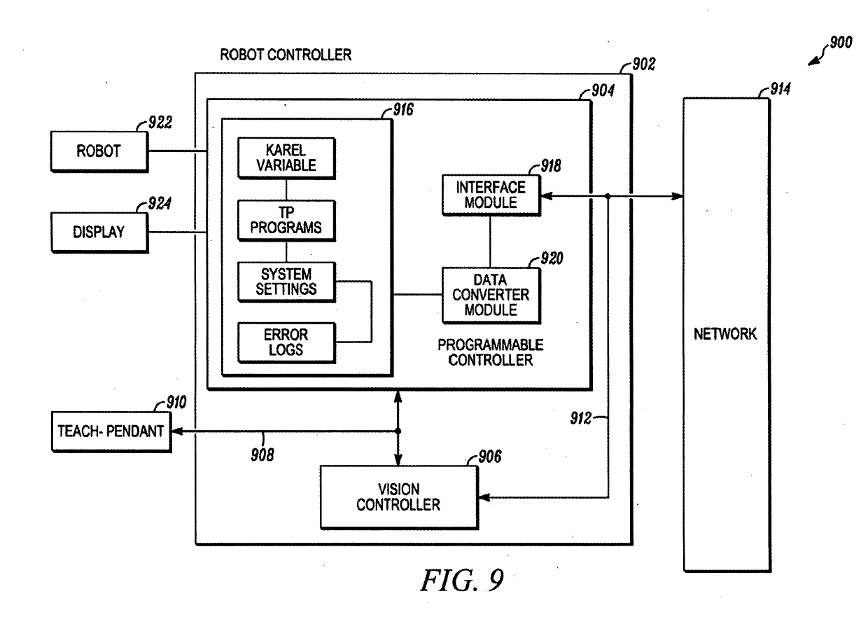

FIG. 9 shows a robotic cell 900 according to another embodiment.

The robotic cell 900 includes a robot controller 902 that includes a programmable controller configured as a robot motion controller 904 and a separate vision controller 906 configured to process or preprocess image information received from one or more image sensors, for example cameras. The robot motion controller 904 and vision controller 906 may each have respective processors and processor readable memory, for example as previously shown and described.

The robotic cell 900 also includes a robot control terminal in the form of a teaching pendant 910. The robot motion controller 904 and vision controller 906 are each communicatively coupled to the teaching pendant 910 via a communications path 908. The communications path 908 provides at least some communications between the robot controller 802 and the vision controller 906. The communications path 908 also advantageously provides at least some communications between the teaching pendant 806 and the vision controller 906 independently (e.g., without intervention) of the robot controller 802.

The robot motion controller 904 may include a control system 916, interface module 918, and/or data converter module 920. The control system 916, interface module 918, and/or data converter module 920 may be similar to or identical to the identically named components described for the embodiment of FIG. 8. The robotic cell 900 may also include a robot 922 and/or display 924. The robot 922 and/or display 924 may be identical or similar to the identically named components described in the embodiment of FIG. 8. Another communications path 912 may communicatively couple the robot motion controller 904 and/or the vision controller 906 to a network 914, for example a network that is external to the robotic cell 900, such as an extranet, intranet or the Internet.

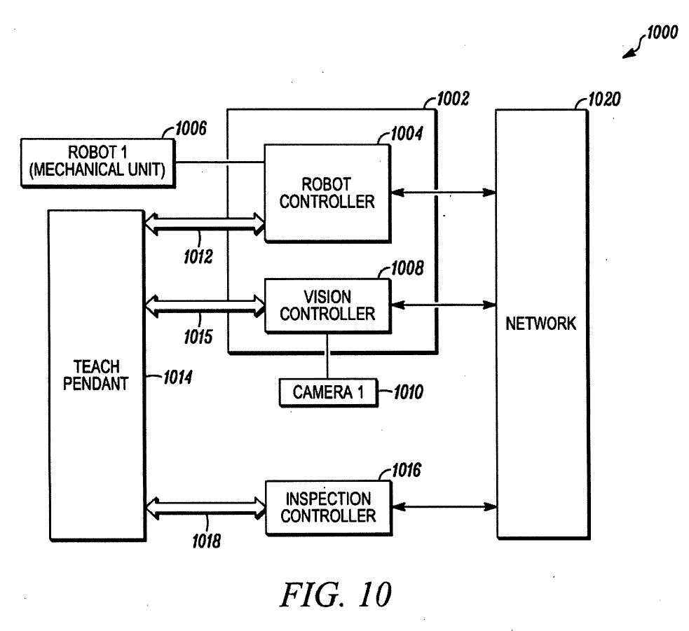

FIG. 10 shows a robotic cell 1000 according to another illustrated embodiment.

The robotic cell 1000 may include a control system 1002 which may include a robot controller 1004 configured to control motion of a robot 1006 and may also include a separate vision controller 1008 configured to process or preprocess image information received from one or more cameras 1010. The robotic cell 1000 may include a robot control terminal in the form of a teaching pendant 1014. A first communications path 1012 may communicatively couple the robot controller 1004 to the teaching pendant 1014. A second communications path may communicatively couple the vision controller 1008 to the teaching pendant 1014. The second communications path 1015 advantageously provides at least some communications between the teaching pendant 1014 and the vision controller 1008 that is independent from the robot controller 1004.

The robotic cell may also include an inspection controller 1016. The inspection controller 1016 may, for example take the form of a programmable controller including a processor and processor readable memory. The inspection controller may be configured via software, firmware or hardwired logic, to perform inspections of a workpiece (not shown in FIG. 10). The inspection controller may receive information or data from various sensors, for example one or more image sensors such as a camera, temperature sensors, proximity sensors, strain gauges, etc. (not shown). A third communications path 1018 may communicatively couple the inspection controller 1016 with the teaching pendant 1014. The third communications path 1018 advantageously provides at least some communications between the teaching pendant 1014 and the inspection controller 1016 that is independent from the robot controller 1004.

Each of the robot controller 1004, vision controller 1008 and/or inspection controller 1016 may be communicatively coupled with one or more networks 1020. The network 1020 may, for example, take the form of a robotic cell network and may provide communications between the robot controller 1004 and the vision controller 1008, or communications between the robot controller 1004 and the inspection controller 1016, and/or communications between the vision controller 1008 and the inspection controller 1016.

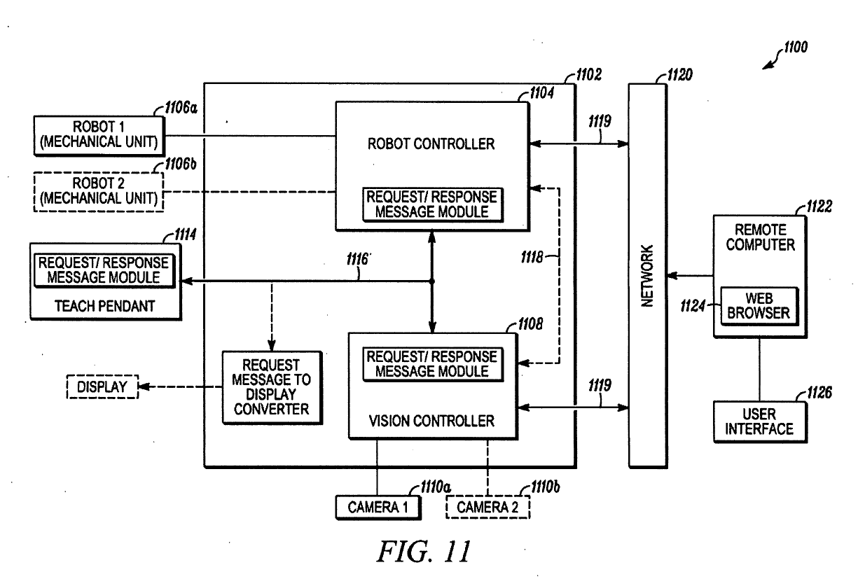

FIG. 11 shows robotic cell 1100 according to another illustrated embodiment.

The robotic cell 1100 includes a control system 1102 that includes a robot controller 1104 configured to control the motion of one or more robots 1106a, 1006b, and a separate vision controller 1108 configured to process or preprocess image information from one or more cameras 110a, 110b. The robotic cell 1100 may include a robot control terminal in the form of a teaching pendant 1114. A first communications path 1116 communicatively couples the robot controller 1104 to the teaching pendant 1114. The first communications path 1116 also communicatively couples the vision controller 1108 to the teaching pendant 1114 to provide at least some communications directly therebetween, independently of the robot controller 1104. A second communications path 1118 may communicatively couple the robot controller 1104 to/with the vision controller 1108.

Other communications paths (collectively 1119) may communicatively couple the robot controller 1104 and/or vision controller 1108 to an external network 1120. Such may allow communications with a remotely located computer 1122 which may execute a web browser 1124. The computer 1122 may take a variety of forms including desktop or personal computers, laptop computers, workstations, main frame computers, handheld computing devices such as personal digital assistants, Web-enabled BLACKBERRY® OR TREO® type devices, cellular phones, etc. Such may allow a remote user to interact with the control system 1102 via a remotely located user interface 1126. The user interface 1126 may take a variety of forms including keyboards, joysticks, trackballs, touch or track pads, hepatic input devices, touch screens, CRT displays, LCD displays, plasma displays, DLP displays, graphical user interfaces, speakers, microphones, etc.

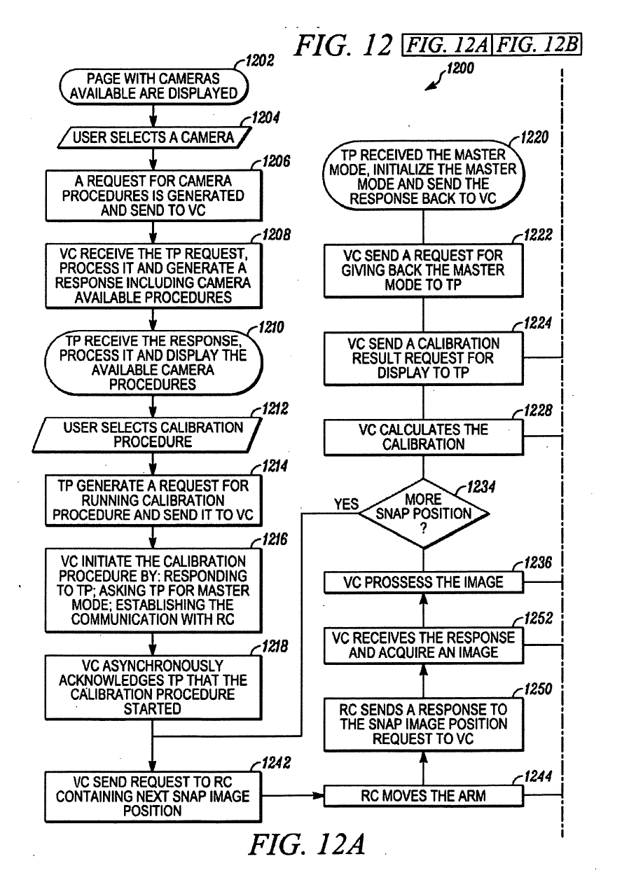

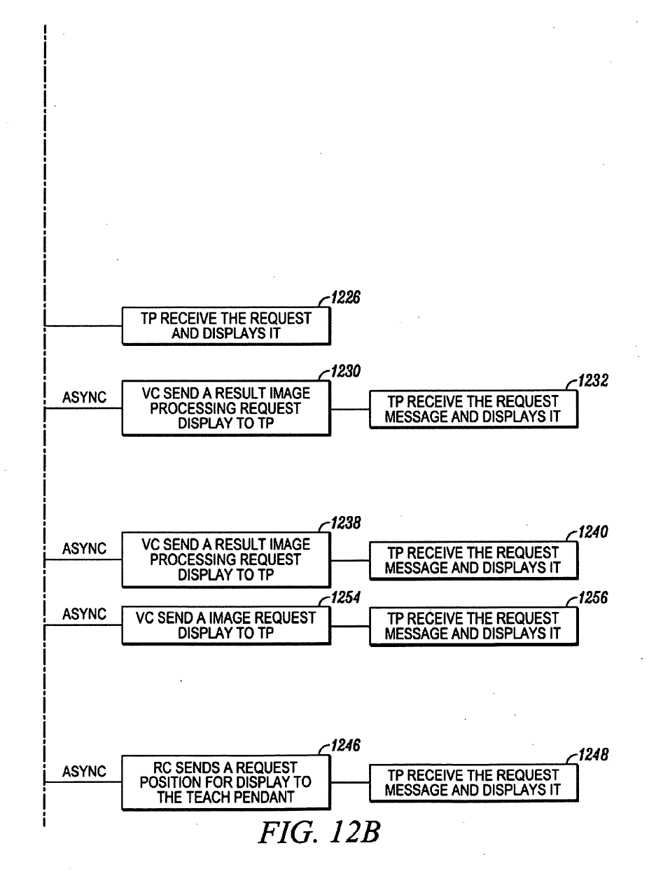

FIGS. 12A and 12B show a method 1200 of operating a robotic cell according to one illustrated embodiment. The method 1200 is described with reference to a robot, robot motion controller, separate vision controller, teaching pendant, and at least one image sensor (e.g., camera) mounted on a portion of the robot for movement therewith. Much of the discussion of method 1200 is applicable to other embodiments or configurations of a robotic cell, or may be generalized to cover such embodiments and configurations.

At 1202, a robot control terminal such as a teaching pendant presents information, for example as a composite page or form or Webpage. The information identifies various image sensors (e.g., cameras) that are available in a robotic cell. At 1204, a user input is received by the teaching pendant, that identifies a selection of an image sensor by the user. The user input may take the form of activation of keys, joystick, rocker switch, track pad, user selectable icons, or other user input devices. At 1206, the teaching pendant generates and transmits a camera procedures request directly to a vision controller, without intervention of a robot controller.

At 1208, the vision controller receives the camera procedures request from the teaching pendant and processes the request. The vision controller generates a response to the camera procedures request, including any available camera procedures, and sends the response directly to the teaching pendant without intervention of the robot controller. At 1210, the teaching pendant receives and processes the response and displays the available camera procedures to a user via a display (e.g., LCD screen) of the teaching pendant.

At 1212, a user input is received by the teaching pendant that is indicative of a user selected calibration procedure. Again, the user input may take the form of activation of keys, joystick, rocker switch, track pad, user selectable icons, or other user input devices. At 1214, the teaching pendant generates a request for running the user selected calibration procedure and transmits the request directly to the vision controller without the intervention of the robot controller.

At 1216, the vision controller initiates the user selected calibration procedure in response to receiving the request from the teaching pendant. Initiation may include responding to the teaching pendant, asking the teaching pendant for a master mode and establishing communication with the robot controller. Again, the communications between the teaching pendant and the vision controller may occur independently of the robot controller. At 1218, the vision controller asynchronously sends an acknowledgment to the teaching pendant that the calibration procedure has started.

At 1220, the teaching pendant receives the master mode, initializes the master mode, and sends a response back to the vision controller. At 1222, the vision controller sends a request for giving back the master mode to the teaching pendant. At 1224, the vision controller sends a request to display the calibration result to the teaching pendant. Again, the communications between the teaching pendant and the vision controller may occur independently of the robot controller. At 1226, the teaching pendant receives the request and displays the calibration results.

At 1228, the vision controller calculates the calibration using any known or later developed calibration procedures. Some examples of calibration may be discussed in U.S. Pat. No. 6,816,755, issued Nov. 9, 2004; U.S. Ser. No. 10/634,874, filed Aug. 6, 2003 and published as U.S. patent application Publication No. 2004-0172164; U.S. Pat. No. 7,336,814, issued Feb. 26, 2008; U.S. Ser. No. 11/534,578, filed Sep. 22, 2006 and published as U.S. patent application Publication No. 2007-0073439; U.S. Ser. No. 11/957,258, filed Dec. 14, 2007; U.S. Ser. No. 11/779,812, filed Jul. 18, 2007; U.S. patent application Publication No. 2007-0276539; U.S. patent application Publication No. 2008-0069435; U.S. Ser. No. 11/833,187, filed Aug. 2, 2007 U.S. Ser. No. 60/971,490, filed Sep. 11, 2007. At 1230, the vision controller asynchronously sends a request to display results of image processing to the teaching pendant. At 1232, the teaching pendant receives the request message and displays the results.

At 1234, the vision controller determines if there is another “snap” position, orientation or pose (i.e., combination of position and orientation). A “snap” position, orientation or pose may take the form of a defined position, orientation or pose for the robotic member and/or image sensor, which may be defined in two- or three-dimensions and may be defined in an variety of reference frames (e.g., robot reference frame, real world or robotic cell reference frame, camera reference frame, etc.). The position, orientation or pose may be predefined or may be defined dynamically, for example in response to user input.

If there are no more snap positions, orientations or poses, control passes to 1236, where the vision controller processes an image captured or otherwise sensed by the image sensor or camera. At 1236, the vision controller sends a request to display results of image processing to the teaching pendant. At 1240, the teaching pendant receives the request message and displays the results.

If at 1234 it is determined that there are more snap positions, orientations or poses, the vision controller sends a request to the robot controller containing a next snap image position, orientation or pose at 1242. At 1244, the robot controller causes at least a portion of a robot (e.g., an arm) to move, thereby repositioning and/or reorienting the camera to the new snap image position, orientation or pose. At 1246, the robot controller sends a request to display the new position, orientation or pose to the teaching pendant. At 1248, the teaching pendant receives the request message and displays information indicative of the new position, orientation or pose.

At 1250, the robot controller sends a response to the snap image position request to the vision controller. At 1252, the vision controller receives a response and acquires an image via the image sensor (e.g., camera). At 1254, the vision controller sends a request to display the image to the teaching pendant. At 1256, the teaching pendant receives the request message and displays the image via the display of the teaching pendant for the user. At 1236, the vision controller processes the image, and returns control to 1234 to determine if there are additional snap positions, orientations or poses. In some embodiments, the teaching pendant could provide communications between the robot controller and the vision controller, for example where there is no direct communications path between the robot and vision controllers.

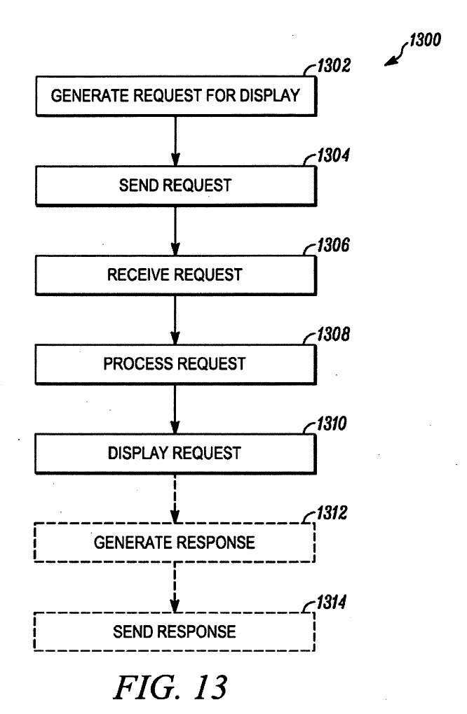

FIG. 13 shows a method 1300 of displaying data in a robotic cell via interactions between a vision controller and a robot control terminal, for example a teaching pendant, according to one illustrated embodiment.

At 1302, a vision controller generates a request for display. At 1304, the vision controller sends the request for display to the teaching pendant. Advantageously, the vision controller sends the request directly to the teaching pendant, independently of a robot controller.

At 1306, the teaching pendant receives the request to display. At 1308, the teaching pendant processes the request. At 1310, the teaching pendant displays the request on the display of the teaching pendant.

Optionally, at 1312, the teaching pendant generates a response to the request. At 1314, the teaching pendant optionally sends the response to the request to the vision controller. Advantageously, the teaching pendant sends the response directly to the vision controller, independently of a robot controller.

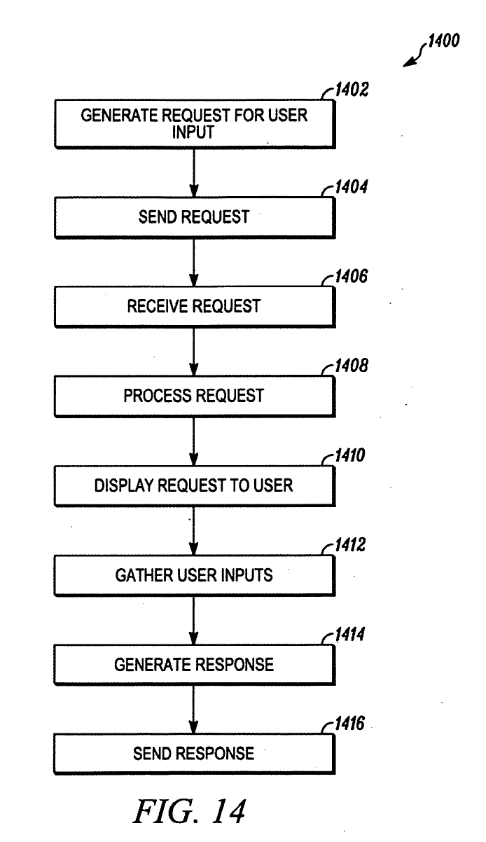

FIG. 14 shows a method 1400 of soliciting user input in a robotic cell via interactions between a vision controller and a robot control terminal, for example a teaching pendant, according to one illustrated embodiment.

At 1402, the vision controller generates a request for user input. At 1404, the vision controller sends the request for user input to the teaching pendant. Advantageously, the vision controller sends the request directly to the teaching pendant, independently of a robot controller.

At 1406, the teaching pendant receives the request for user input. At 1408, the teaching pendant processes the request for user input. At 1410, the teaching pendant displays the request to the user. Alternatively, or additionally, the teaching pendant may provide an aural or audible indication of the request.

At 1412, the teaching pendant gathers user inputs. At 1414, the teaching pendant generates a response to the request for user input based on the gathered user inputs. At 1416, the teaching pendant sends the response to the request for user input to the vision controller. Advantageously, the teaching pendant sends the response directly to the vision controller, independently of a robot controller.

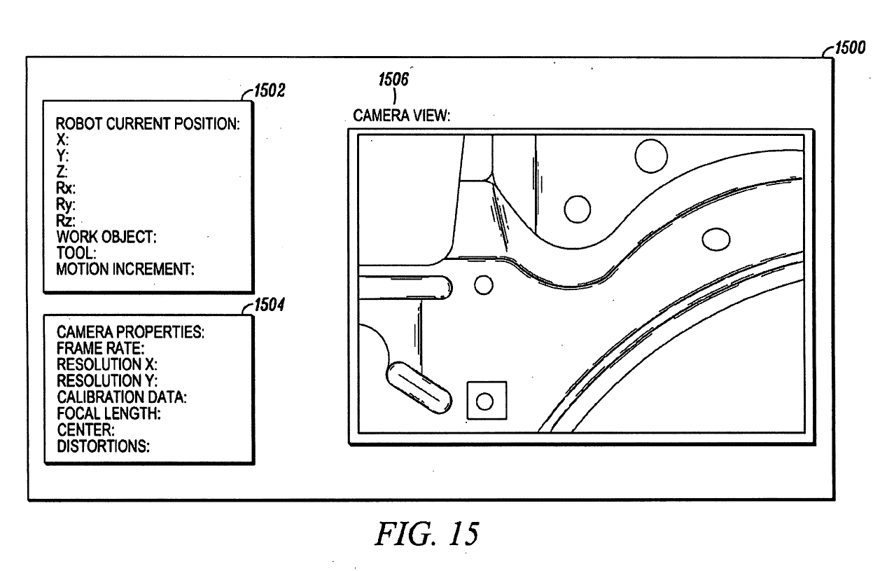

FIG. 15 shows a portion of a user interface 1500 as presented on a display of a robot control terminal such as a teaching pendant, according to one illustrated embodiment.

The user interface 1500 may include robot related information or data 1502 received from a robot controller. Such may, for example, include information indicative of: a current position (e.g., X, Y, Z) of one or more portions of the robot, a current orientation (e.g., Rx, Ry, Rz) of one or more portions of the robot, an identification of a workpiece (e.g., Work Object), identification of a tool (e.g., Tool, for instance grasper, welding torch, etc.), and an amount of motion increment (e.g., motion increment).

The user interface 1500 may provide camera related information or data 1504 received from the vision controller, independently of the robot controller. Such may, for example, include information indicative of: camera properties (e.g., Camera properties), camera frame rate (e.g., Frame rate), camera resolution in two dimensions (e.g., Resolution X, Resolution Y), camera calibration data (e.g., Calibration data)), camera focal length (e.g., Focal length), camera center (e.g., Center) and/or camera distortion (e.g., Distortions). Such may additionally, or alternatively include information indicative of a position, orientation or pose of the workpiece, for instance as determined by the vision controller. The user interface 1500 may also provide one or more images 1506 captured by one or more of the image sensor, such as a user selected camera. Such may, for example, show a portion of a workpiece as imaged by a selected camera.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other robotic systems, not necessarily the exemplary robotic systems generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A machine-vision based robotic system, comprising:
a machine vision controller coupled to receive image information from at least one image sensor and configured to process at least some of the image information;
a robot motion controller configured to control movement of a robotic member based at least in part on the processed image information captured by the at least one image sensor; and
a teaching pendant interface communicatively coupled to provide at least some communications between a teaching pendant and the robot controller and communicatively coupled to provide at least some communications between the teaching pendant and the machine vision controller directly without intervention of the robot motion controller.

2. The machine-vision based robotic system of claim 1 wherein the teaching pendant interface includes at least one communications channel between the teaching pendant and robot motion controller and at least one communications channel between the teaching pendant and the machine vision controller that is at least in part parallel to the communications channel between the teaching pendant and the robot motion controller.

3. The machine-vision based robotic system of claim 1 wherein the machine vision controller includes at least a first processor and the robot motion controller includes at least a second processor.

4. The machine-vision based robotic system of claim 1, further comprising:
a programmable logic controller wherein the teaching pendant interface is communicatively coupled to provide at least some communications directly between the teaching pendant and the programmable logic controller directly without intervention of the robot motion controller.

5. The machine-vision based robotic system of claim 4 wherein the teaching pendant interface includes at least one communications channel between the teaching pendant and robot motion controller, at least one communications channel between the teaching pendant and the machine vision controller that is at least in part parallel to the communications channel between the teaching pendant and the robot motion controller, and at least one communications channel between the teaching pendant and the programmable logic controller that is at least in part parallel to the communications channel between the teaching pendant and the robot motion controller.

6. The machine-vision based robotic system of claim 1 wherein the teaching pendant interface is communicatively coupled to provide two-way communications between the teaching pendant and the robot motion controller and to provide two-way communications between the teaching pendant and the machine vision controller.

7. The machine-vision based robotic system of claim 1, further comprising:
a robotic cell network interface communicatively coupled to provide direct two-way communications between the teaching pendant and a robotic cell network.

8. The machine-vision based robotic system of claim 1, further comprising:
an external network interface communicatively coupled to provide direct two-way communications between the teaching pendant and an external network that is external from a robotic cell.

9. The machine-vision based robotic system of claim 1, further comprising:
at least one of the robotic member, the first image sensor or the teaching pendant.

10. The machine-vision based robotic system of claim 1 wherein the robot motion controller and the machine vision controller are each communicatively coupleable to one another to provide communications therebetween.

11. A machine-vision based robotic system, comprising:
at least a first robotic member that is selectively movable;
at least a first image sensor operable to produce information representative of images;
a user operable handheld robot control terminal including at least one user input device operable by a user;
a robot motion controller configured to control movement of at least the first robotic member;
a machine vision controller coupled to receive information directly or indirectly from at least the first image sensor
wherein the handheld robot control terminal and the robot motion controller are communicatively coupled to provide at least some communications between the handheld robot control terminal and the robot motion controller, and
wherein the handheld robot control terminal and the machine vision controller are communicatively coupled to provide at least some communications between the handheld robot control terminal and the machine vision controller independently of the robot motion controller.

12. The machine-vision based robotic system of claim 11 wherein the machine vision controller includes at least a first processor and the robot motion controller includes at least a second processor.

13. The machine-vision based robotic system of claim 11, further comprising:
a programmable logic controller wherein the handheld robot control terminal is communicatively coupled in parallel to the robot motion controller and the programmable logic controller to provide at least some communications directly between the handheld robot control terminal and the programmable logic controller without intervention of the robot motion controller.

14. The machine-vision based robotic system of claim 11 wherein the robot motion controller and the machine vision controller are each communicatively coupleable to an external network that is external from a robotic cell.

15. The machine-vision based robotic system of claim 11 wherein the robot motion controller and the machine vision controller are each communicatively coupleable to one another to provide communications therebetween.

16. The machine-vision based robotic system of claim 11 wherein the handheld robot control terminal includes at least one display and is configured to present images from the first image sensor on the at least one display.

17. The machine-vision based robotic system of claim 11 wherein the handheld robot control terminal includes at least one user input device and is configured to provide data to the robot motion controller to move at least the first robotic member in response to operation of the user input device.

18. The machine-vision based robotic system of claim 11 wherein the handheld robot control terminal is a teaching pendant.

19. The machine-vision based robotic system of claim 11, further comprising:
at least one tangible communications channel providing communications between the handheld robot control terminal and the robot motion controller.

20. The machine-vision based robotic system of claim 11, further comprising:
a communications conduit that carries bidirectional asynchronous communications between the handheld robot control terminal and both the robot motion controller and the machine vision controller.

21. The machine-vision based robotic system of claim 11, further comprising:
a robotic cell network that carries bi-directional communications between the handheld robot control terminal and both the robot motion controller and the machine vision controller.

22. A method of operating a machine vision system, the method comprising:
providing at least some communications between a teaching pendant and a robot motion controller;
providing at least some communications between the teaching pendant and a machine vision controller independently of the robot motion controller; and
causing a robot member to move in response to communications between the teaching pendent and the robot motion controller.

23. The method of claim 22 wherein providing at least some communications between the teaching pendant and a machine vision controller independently of the robot motion controller includes providing at least some communications along an independent communications path at least a portion of which is parallel to a communications path between the teaching pendant and the robot motion controller.

24. The method of claim 22 wherein providing at least some communications between the teaching pendant and a machine vision controller independently of the robot motion controller includes providing at least some communications via a robotic cell bidirectional asynchronous communications network.

25. The method of claim 22, further comprising:
displaying a representation of data from the robot motion controller at the teaching pendant in real time; and
displaying a representation of data from the machine vision controller at the teaching pendant in real time.

26. The method of claim 25 wherein the representation of data from the machine vision controller is displayed at the teaching pendant concurrently with the representation of data from the robot motion controller.

27. The method of claim 22 wherein providing at least some communications between the teaching pendant and a machine vision controller independently of the robot motion controller includes transmitting image data from the machine vision controller to the teaching pendant for display thereby directly, without intervention of the robot motion controller.

28. The method of claim 22, further comprising:
providing at least some communications between a processor of the machine vision controller and a processor of the robot motion controller.

29. The method of claim 22, further comprising:
providing at least some communications between the teaching pendant and a third controller independently of the robot motion controller.

30. The method of claim 22, further comprising:
providing communications between the robot motion controller and an external network that is external from a robotic cell; and
providing communications between the machine vision controller and the external network.

31. The method of claim 22, further comprising:
prompting a user for a user input at the teaching pendant in response to at least some of the communications between the teaching pendant and the vision controller; and
receiving at least one user input at the teaching pendant, wherein providing at least some communications between the teaching pendant and the machine vision controller includes transmitting at least one signal indicative of the at least one user input from the teaching pendant to the machine vision controller independently of the robot motion controller.

32. The method of claim 22, further comprising:
performing a discover service on the teaching pendant.

33. The method of claim 32 wherein performing a discover service on the teaching pendant includes identifying any new hardware added to a robotic cell since a previous discover service action.

34. The method of claim 32 wherein performing a discover service on the teaching pendant includes identifying any new software added to a robotic cell since a previous discover service action.
